(19) United States
(12) Patent Application Publication
(10) Pub. No.: US 2007/0108706 A1
(43) Pub. Date: May 17, 2007

(54) Tool connector having multiple locking positions

(75) Inventors: W. Robert Cornwell, Ronan, MT (US); Nathan C. Cantlon, Charlo, MT (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Jore Corporation, Pasco, WA (US)

(21) Appl. No.: 11/364,880

(22) Filed: Feb. 27, 2006

Related U.S. Application Data
(60) Provisional application No. 60/656,816, filed on Feb. 25, 2005.

(51) Int. Cl. B23B 31/02

(52) U.S. Cl. 279/143

(57) ABSTRACT

A connector for a hand tool is provided. The connector includes a tool receiving portion configured to receive any one of a plurality of work tool pieces of the type having one of either at least a first or second locking configuration, wherein the first locking configuration is different at least in part from the second locking configuration. The connector also includes a locking mechanism coupled to the tool receiving portion and adapted to selectively couple any one of the plurality of work tool pieces to the connector.

### CROSS-REFERENCE TO RELATED APPLICATION

This application claims the benefit of Provisional Application No. 60/656,816, filed Feb. 25, 2005, the disclosure of which is hereby expressly incorporated by reference.

### TECHNICAL FIELD

The embodiments described herein relate generally to tool connectors, and more specifically to tool connectors having multiple locking positions.

### BACKGROUND

Tool connectors for tools having a hex shank attachment end are known in the market and have many variations. One such tool connector is set forth in U.S. Pat. No. 6,543,959, issued to Jore Corporation. Such connectors are designed to accept only specifically sized tools, such as one-inch long wire detent style hex bits or two-inch long power driver hex bits with a circumferential ball detent groove in the hex shank. The two-inch bit must necessarily sit deeper in the tool connector in order to transmit torque both forward and aft of the circumferential groove. However, if the one-inch bit were to be seated in this same depth it would be difficult to grasp the bit during removal, and the bit could become jammed into the connector. Thus, a single connector cannot be used to drive tools of different sizes and lock configurations.

### SUMMARY

A connector for a hand tool is provided. The connector includes a tool receiving portion configured to receive any one of a plurality of work tool pieces of the type having one of either at least a first or second locking configuration, wherein the first locking configuration is different at least in part from the second locking configuration. The connector also includes a locking mechanism coupled to the tool receiving portion. The locking mechanism is adapted to selectively couple any one of a plurality of work tool pieces to the connector.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of the claimed subject matter will become better understood by reference to the following detailed description, when taken in conjunction with the accompanying drawings, wherein:

FIG. 1 is an isometric view of a tool connector constructed in accordance with one embodiment of the present disclosure;

FIG. 2 is an exploded view of the tool connector of FIG. 1;

FIG. 3 is a partial cross-sectional side view of the tool connector of FIG. 1 without a driver bit, taken substantially through section A-A of FIG. 1;

FIG. 4 is a partial cross-sectional side view of the tool connector of FIG. 1 taken substantially through section A-A of FIG. 1 and showing the tool connector in an unlocked position;

FIG. 5 is a partial cross-sectional side view of the tool connector of FIG. 1 taken substantially through section A-A of FIG. 1 and showing the tool connector in a locked position;

FIG. 6 is a partial cross-sectional side view of the tool connector of FIG. 1 taken substantially through section A-A of FIG. 1 and showing the tool connector with a power driver bit and in the unlocked position; and

FIG. 7 is a partial cross-sectional side view of the tool connector of FIG. 1 taken substantially through section A-A of FIG. 1 and showing the tool connector with a power driver bit and in the locked position.

### DETAILED DESCRIPTION

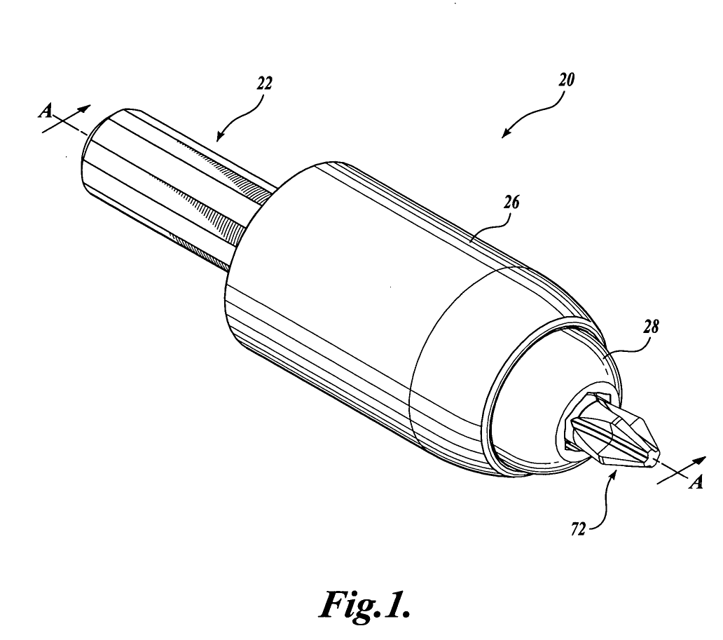

A tool connector 20 constructed in accordance with one embodiment of the present disclosure may be best understood by referring to FIGS. 1-5. The tool connector 20 is preferably constructed of steel or aluminum, yet any material of suitable strength and durability may be used.

The tool connector 20 includes a shank 22, a shuttle 24, a collar 26, and a shaft 28. The shank 22, shuttle 24, collar 26, and shaft 28 are coupled together to cooperatively form the tool connector 20 having a tool receiving portion and a locking mechanism. For ease of illustration and clarity, the tool connector 20 is mostly shown in a substantially horizontal orientation, although it may be suitably used in any orientation, such as vertical. Therefore, terminology, such as “front,” “rear,” “forward,” “rearward,”etc., should be construed as merely descriptive and not limiting. Further, although certain geometric shapes may be illustrated and described below, it should be understood that such terms are intended to be merely descriptive and not limiting. Hence, other geometric shapes, such as oval, round, square, etc., are also within the scope of the present disclosure.

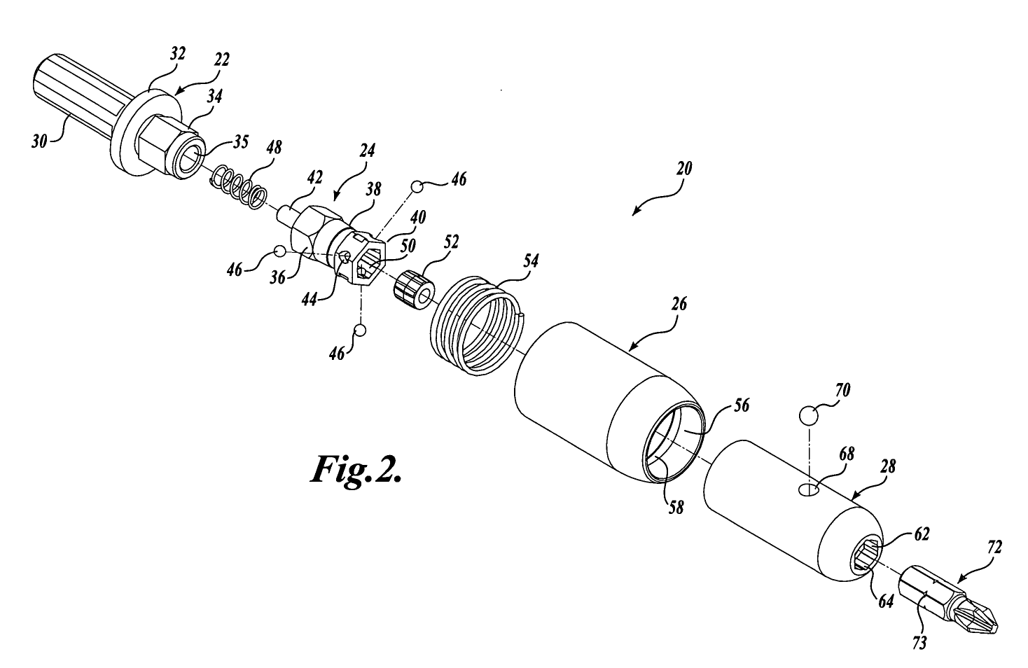

As may be seen best by referring to FIG. 2, the shank 22 includes an attachment end 30 that is suitably sized and shaped to be received and retained within the receptacle or chuck of any standard hand drill or similar tool. Opposite the attachment end 30 and coaxial with the shank 22 is a hexagonal end 34. The hexagonal end 34 is sized to be fixedly received within a correspondingly shaped cavity 62 of the shaft 28 (as later described).

The shank 22 includes a bore 35 extending partially from the hexagonal end 34 towards the attachment end 30. The bore 35 is sized and configured to receive a coil spring 48 and a boss 42 of the shuttle 24, as described in greater detail below. The shank 22 also includes a flange 32 suitably located between the attachment end 30 and the hexagonal end 34. The flange 32 is sized to be received within the collar 26 and abut one end of the shaft 28 when the tool connector 22 is assembled.

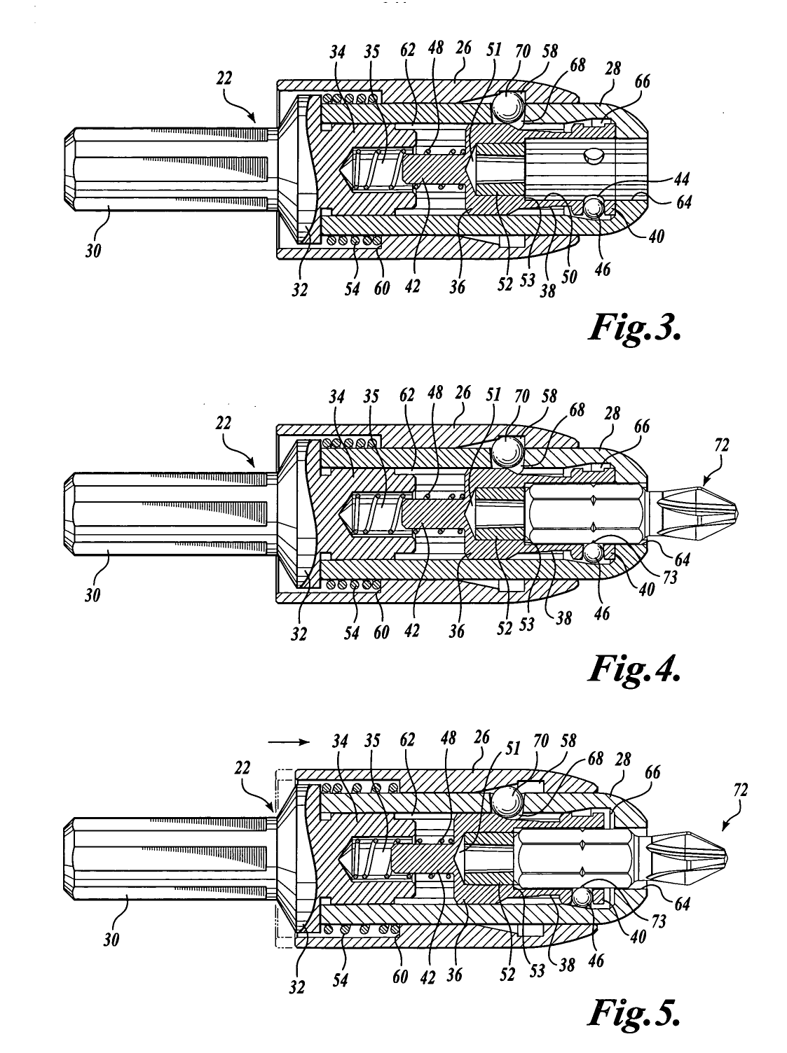

The shuttle 24 is suitably formed from a high strength material and includes first and second hexagonal ends 36 and 40. As may be best seen by referring to FIGS. 3-5, groove 38 is formed on the perimeter of the shuttle 24 and is suitably located between the first and second hexagonal ends 36 and 40. The groove 38 is stepped along its longitudinal axis and it increases in depth as it transitions from near the first hexagonal end 36 towards the second hexagonal end 40.

The shuttle 24 includes a cavity 50 extending from the end surface of the second hexagonal end 40 through at least a portion of the shuttle 24, as shown in FIG. 3. The cavity 50 defines a tool receiving portion and is sized and configured to receive a hexagonally shaped attachment end of a work tool piece, such as a drill bit, a screw driving bit, or similar accessory.

A plurality of tapered holes 44 are spaced circumferentially about the second hexagonal end 40. Each tapered hole 44 passes from the outside surface of the second hexagonal end 40 to the first cavity 50, i.e., normal to the longitudinal axis of the shuttle 24. The tapered holes 44 are sized to receive a ball bearing 46. The tapered ends of the holes 44 are smaller in diameter than the ball 46 such that a ball 46 protrudes only slightly into the first cavity 50 when received within a tapered hole 44. Preferably, the second hexagonal end 40 includes three tapered holes 44 spaced equidistant from each other around the circumference of the second hexagonal end 40.

As may be best seen by reference to FIG. 3, the shuttle 24 includes a second cavity 51 located adjacent the first cavity 50 and within the shuttle 24. The second cavity 51 has a smaller diameter than the diameter of the first cavity 50 to form an annular lip 53 opposite the open end of the first cavity 50. The second cavity 51 is suitably sized to receive a plug 52.

The plug 52 is generally cylindrical in shape and includes a slightly tapered thru-hole along the center longitudinal axis. The plug 52 is received within the second cavity 51 and is attached within the second cavity 51 in any suitable manner, such as friction fit. Preferably, the plug 52 is positioned within the first and second cavities 50 and 51 to provide an abutment to a work tool piece disposed within the first cavity 50. Although a plug 52 is preferred, it should be apparent that other embodiments are also within the scope of the disclosure. As non-limiting examples, the lip 53 may be sized to provide abutting engagement with a tool work piece, or the shuttle 24 may be formed without the second cavity 51 such that a work tool piece disposed within the first cavity 50 abuts the terminal end of the first cavity 50. Accordingly, these and other embodiments are within the scope of the present disclosure.

The shuttle 24 also includes a stem 42 extending from the first hexagonal end 36. The stem 42 is sized to be slidably received within the bore 35 of shank 22. An inner coil spring 48 is mounted on the stem 42 such that the end of the coil spring 48 abuts the first hexagonal end 36 surface of the shuttle 24 to bias the shuttle away from the shank 22 when the stem 42 is received within the bore 35.

Referring to FIGS. 2 and 3, the collar 26 includes a cavity 56 extending between openings at each end of the collar 26. The cavity 56 is sized and configured to receive the shaft 28. A circumferential taper groove 58 is formed within the cavity 56, with the deepest portion of the taper groove 58 located near one open end of the collar 26. The taper groove 58 is sized to partially receive a ball bearing 70 to reciprocate the ball bearing 70 into and out of locking engagement and form a first ball detent mechanism.

The collar 26 also includes an annular retention shoulder 60. The retention shoulder 60 is formed within the cavity 56 and is positioned to assist in biasing a coil spring 54, as described in greater detail below.

Still referring to FIGS. 2 and 3, the shaft 28 is hollow and generally cylindrical in shape. The shaft 28 is sized to be slidably received within the cavity 56 of the collar 26 such that at least a portion of the shaft 28 protrudes out of the collar 26 (FIG. 1). The hollow interior of the shaft 28 is polygonal in shape and forms a cavity 62. Preferably, the cavity 62 is hexagonal in cross-section to slidably receive the shuttle 24 and the hexagonal end 34 of shank 22. One end of the shaft 28 includes a hex shaped opening 64 sized and configured to receive a correspondingly shaped attachment end of a work tool piece of the type described above. For example, FIGS. 4 and 5 show the tool connector 20 receiving a driver bit 72 with detents 73. The detents 73 may also be referred to as a feature of a first locking configuration.

Adjacent the opening 64 and within the cavity 62 of the shaft 28 is a circumferential tapered clearance groove 66. The deepest portion of the groove 66 is located adjacent the opening 64. The groove 66 partially receives a plurality of ball bearings 46, such that the groove 66 and ball bearings 46 form a second ball detent mechanism, as described in greater detail below.

Now referring to FIG. 3, the shank 22, shuttle 24, collar 26, and shaft 28 are coupled together to cooperatively form the tool connector 20 having a tool receiving portion and a locking mechanism. The ball bearing 70 is first received within the tapered hole 68 of shaft 28. Thereafter, the shaft 28 is slidably received in the cavity 56 of the collar 26 so that the ball bearing 70 is received into the taper groove 58 of the collar 36. The outer coil spring 54 is received within the cavity 56 and is seated on the retention shoulder 60.

The plug 52 is then received into the cavity 51 of the shuttle 24. The ball bearings 46 are received within the tapered holes 44 of the second hexagonal end 40 of the shuttle 24. The shuttle 24 is slidably received within the opening of the shaft 22 so that the shuttle's second hexagonal end 40 abuts the interior end surface of the shaft 28 to align the first cavity 50 of the shuttle 24 with the opening 64 of the shaft 28. The ball bearings 46 are partially received into the groove 66 of the collar 26 while still remaining partially received within the tapered holes 44. In addition, the first hexagonal end 36 of the shuttle 24 engages the ball bearing 70 and urges the ball radially outwardly into the taper groove 58 of the collar 26.

The inner coil spring 48 is received onto the stem 42 of the shuttle 24 and the hexagonal end 34 of shank 22 is fixedly received within the opening of the shaft 28. Preferably, the hexagonal end 34 of shank 28 is press-fit within the opening of the shaft 22, but other suitable methods of attachment may also be used. The end of the inner coil spring 48 and at least a portion of the stem 42 are received within the bore 35 of the hexagonal end 34. The inner coil spring 48 biases the shuttle 24 in a direction opposite the shank 22 to maintain the position of the shuttle 24 against the end interior surface of the shaft 28. In this manner, the first end 36 of the shuttle 24 continuously urges the ball bearing 70 into the taper groove 58 of the collar 26 and therefore maintains the collar 26 in an unlocked position until the tool connector 20 is displaced into the locked position.

When the hexagonal end 34 is received within the cavity 62 of the shaft 28, the flange 32 abuts the end of the shaft 28 and the outer coil spring 54 is disposed between the perimeter edge of the flange 32 and the retention shoulder 60. The outer coil spring 54 biases the collar 26 in a direction opposite the flange 32.

Now referring to FIG. 4, when the shuttle is in the forward or unlocked position, the plurality of ball bearings 46 are aligned with the clearance groove 66 in the shaft 28 and are able to move radially outward, allowing a tool work piece, such as a hex driver bit 72, to be inserted into the tool connector 20. The driver bit 72 is inserted into the opening 64 of the shaft 28 and is received into the shuttle 24. When the driver bit 72 is fully received within the shuttle 24, the detents 73 of the driver bit 72 align with the ball bearings 46.

Referring to FIG. 5, the driver bit 72 is locked into the connector 20 by applying a force to the driver bit 72 to urge the shuttle 24 rearward against the force of the inner coil spring 48. As the shuttle 24 is translated rearwardly within the shaft 28, the plurality of ball bearings 46 follow the contoured surface of the tapered clearance groove 66 and are urged radially inward, clamping down on the driver bit 72. At the same time, the ball bearing 70 is urged radially inward into the stepped groove 38 of the shuttle 24 by the force of the collar 26. As the ball bearing 70 is urged radially inward, it falls out of the taper groove 58 of the collar. The outer coil spring 54 then causes the collar 26 to translate forward, locking the ball bearing 70 in a first position within the contour of the stepped groove 38 and preventing the shuttle 24 from moving forward. Thus, the first and second ball detent mechanisms interact with the longitudinal translations of the collar 26 and shuttle 24 to form a locking mechanism that locks the connector 20 in a first position. In this first locked position, the driver bit 72 may be retained and torqued by the tool connector 20.

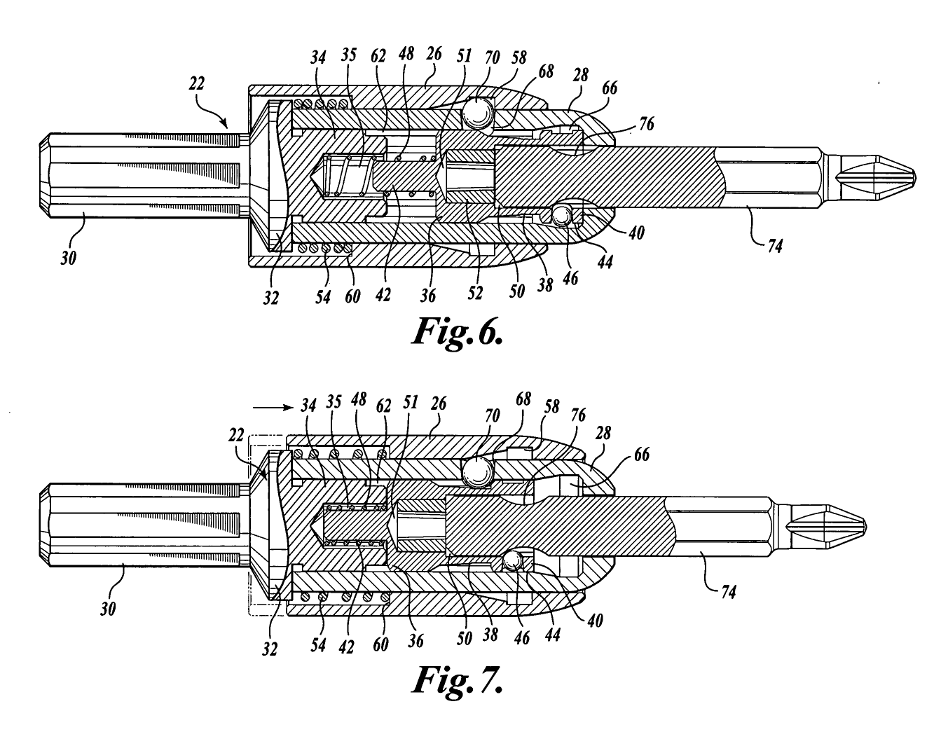

The locking mechanism may also be used to displace the connector 20 into a second locking position for a second work tool piece, different at least in part from the driver bit 72, which may be best understood by referring to FIG. 6. In this aspect, a second driver bit 74 having a ball detent groove 76 (also referred to as a second locking configuration) may be received and retained within the tool connector 20. When the shuttle 24 is in the forward or unlocked position, the plurality of ball bearings 46 are aligned with the clearance groove 66 in the shaft 28 and are able to move radially outward, allowing the second driver bit 74 to be inserted into the tool connector 20. The second driver bit 74 is inserted into the shaft 28 and is received into the cavity 50 of the shuttle 24. As received, the ball detent groove 76 of the second drive bit 74 aligns with the ball bearings 46.

As shown in FIG. 7, when the shuttle 24 is urged rearward towards the shank 22, the ball bearings 46 follow the surface of the taper groove 66 of the shaft 28 and are urged into the ball detent groove 76 of the second driver bit 74. When the ball bearings 46 are received within the ball detent groove 76, they clear the taper groove 66 in the shaft 28. In this manner, the shuttle can be urged axially rearward until it comes into contact with the shank 22.

As the shuttle 24 moves rearward, the ball bearing 70 is urged radially inward into the stepped groove 38 of the shuttle 24 by the force of the collar 26. With the shuttle 24 engaging the shank 22, the ball bearing 70 is received into the deepest portion of the stepped groove 38, or the second position. As the ball bearing 70 is urged radially inward, the outer coil spring 54 causes the collar 26 to translate forward, locking the ball bearing 70 in the second position and preventing the shuttle 24 from moving forward. In this second locked position, the second driver bit 74 may be retained and torqued by the tool connector 20.

As shown in FIGS. 4-7, the tool connector 20 of the present disclosure is capable of receiving and lockingly engaging tool work pieces of two different structural designs. The tool connector 20 may be used to receive, retain, and torque tool work pieces of multiple structural designs, such as (for non-limiting examples) one-inch and two-inch hex driver bits. Therefore, the tool connector 20 is configured to receive any one of a plurality of work tool pieces of the type having one of either at least a first or second locking configuration, wherein the first locking configuration is different at least in part from the second locking configuration. However, it should be appreciated that the tool connector 20 may also be configured to receive work tool pieces of other configurations, such as a hexagonal bit without detents or bits of other lengths.

The first and second driver bits 72 and 74 can be unlocked from the tool connector 20 by urging the collar 26 rearward against the force of the outer coil spring 54 until the deepest portion of the taper groove 58 is positioned above the ball bearing 70. With the ball bearing 70 adjacent the deepest portion of the taper groove 58, the ball bearing 70 is no longer retaining the shuttle 24 in its locked position. Thus, the shuttle 24 is urged forward by the force of the inner coil spring 48. The shuttle 24 translates forward while the stepped groove 38 and first hexagonal portion 36 of the shuttle 24 simultaneously urge the ball bearing 70 into the taper groove 58. The shuttle 24 is urged forward until the plurality of ball bearings 46 are positioned adjacent the clearance groove 66 and are urged radially outward into the clearance groove 66, thereby disengaging the bit and allowing the bit to be removed from the connector 20.

While illustrative embodiments have been illustrated and described, it will be appreciated that various changes can be made therein without departing from the spirit and scope of the application.

The embodiments of the invention in which an exclusive property or privilege is e defined as follows:

1. A connector for a hand tool, the connector comprising:
(a) a tool receiving portion configured to receive any one of a plurality of work tool pieces of the type having one of either at least a first or second locking configuration, wherein the first locking configuration is different at least in part from the second locking configuration; and
(b) a locking mechanism coupled to the tool receiving portion and adapted to selectively couple any one of the plurality of work tool pieces to the connector when any one of the plurality of work tool pieces is received by the tool receiving portion.
